(19) United States
(12) Patent Application Publication
(10) Pub. No.: US 2002/0041289 A1
(43) Pub. Date: Apr. 11, 2002

(54) Method and apparatus for producing functionality and user interfaces for devices having an embedded operating system

(76) Inventors: John D. Hatch, Kirkland, WA (US); Adam Almog, Seattle, WA (US); Steven Yee, Renton, WA (US); Anthony D. Cao, Bothell, WA (US)

Correspondence Address: LARIVIERE, GRUBMAN & PAYNE, LLP, 1 LOWER RAGSDALE, BLDG. 1, SUITE 130, P.O. BOX 3140, MONTEREY, CA, 93942, US

(21) Appl. No.: 09/935,181

(22) Filed: Aug. 21, 2001

Related U.S. Application Data
(60) Provisional application No. 60/226,734, filed on Aug. 21, 2000.

(51) Int. Cl. G06F 3/00

(52) U.S. Cl. 345/762

(57) ABSTRACT

The present invention is a comprehensive, flexible and extensible software technology used to easily create, implement and modify User Interfaces (UIs) and shells. The software tool includes a powerful design framework suitable for general purpose computing devices and ideal for mission-focused embedded devices. The software tools offers unlimited variations of navigational structure and appearance; an expansive choice of component commands with a simple scripting language; an ability to switch easily among multiple personalities on a single machine; and administrative control over permissions to password-protected commands. The shell functionality produced by the software includes application launching; file and task management; flexible control panels; power notifications; and shell application programming interfaces.

### FIELD OF THE INVENTION

This invention pertains generally to processor-based devices with user interfaces; and, more particularly, to rendering graphical user interfaces (UIs) and providing device functionality customizable through a scripting language.

### BACKGROUND OF THE INVENTION

The advent of powerful new processors and peripheral technologies has brought about an industry need for software tools to easily create, implement and modify User Interface (UI) shells and applications. Original equipment manufacturers (OEMs) particularly seek new technology to provide appealing interfaces and functionality for mission-focused computer devices such as Internet Appliance products. These products require consumer-quality user interfaces within an embedded software framework. Unfortunately, there is no standard interface for these devices. Furthermore, the graphical style of the user interface may depend on the targeted use of the device. Often, the same model of hardware device targets markets having different specific use requirements. Thus, the need for UI development becomes acute. Additionally, the fact that these devices use embedded operating systems adds another layer of complexity to UI development. Many OEMs face exceedingly short development cycles to remain competitive. Many also lack the requisite experience with embedded development to tackle the problem of providing customized UIs having rich functionality.

Microsoft® recognized the need to provide programmatic interfaces to their Internet Explorer® so that applications could integrate browser functionality. Such interfaces are described in the U.S. Pat. No. 6,101,510, which is incorporated herein by reference. Although this is a good approach for individual applications it is not intended to provide a comprehensive solution for entire UI development, including performing functions of an OS shell, and allowing for easy creation an customization using standard web authoring tools.

Others have attempted to create UIs and shells using web-style approaches. Microsoft's Mariner web companion SDK is one example, Netpliance's HTML based User Interface is another example. There are some scripting tool solutions, such as Microsoft's Windows Script, which attempt to solve some of the problems. Microsoft's Visual Basic attempts to solve similar problems in that it is fairly easy to create application UI's and somewhat scriptable.

The above attempts, however, do not address the need to replace or provide full shell functionality. There are some customizable shell products available. Many exist for Unix; few solutions exist for Windows Desktops, and even fewer exist for Windows Embedded OS's.

Microsoft's IE browser control by itself does not provide a comprehensive solution for entire UI development. While it does allow the developer to render images using HTML and supports scripting using Jscript, it is only suitable for individual applications. It does not allow the OEM to create an embedded shell for their device. Neither is the scripting directly exposed to the shell or application; it is handled entirely within the browser control.

Furthermore, single purpose and narrow focus approaches, such as Microsoft's Mariner SDK and Netpliance's targeted single UI, are not general, extensible or easily customizable. Visual Basic requires a large footprint and therefore is a more expensive solution for embedded devices. Also, it does not provide full shell functionality and does not permit creation using standard web site authoring tools.

None of the above “solutions” address the need to create a customizable shell. The shell is the exposed interface of the operating system. It provides services to tasks, task management, and a means for a user to launch and switch between tasks. Without the shell, a monolithic application would need to be developed. This is undesirable because it is neither modular nor easily extensible. The shell provides a modular and extensible framework for application development.

Customizable shell products address the need to some extent, but they do not utilize today's web development standards, and/or are not suitable for embedded environments due to inordinate hardware requirements or incompatibilities with the embedded OS; e.g., large footprints. Nor do such customizable shell products provide the means to customize applications in the same manner as the shell.

Therefore, there is a need for technology to develop software for these processor-based devices using standard web development tools that would significantly shorten the development cycle and eliminate the need to invest time and resources learning the intricacies of the embedded OS. There is a further need for an easy way to modify, update or replace the user interface over the Internet. The present invention satisfies those needs, as well as others, and provides an underlying software technology that allows OEMs to easily create, implement and modify the User Interface environment for processor-based devices, such as Internet appliances, using nothing more than common web site authoring tools.

### BRIEF SUMMARY OF THE INVENTION

The present invention is a method and apparatus for producing user interfaces (UIs) and functionality for processor-based devices (hereafter, computers) having an embedded operating system, such as Internet Appliances. The present invention includes scriptable control of the creation of objects through HTML and/or scripting languages; e.g., Jscript, for easy customization of an entire UI. The scriptable control ensures easy creation or modification of a master script file by a developer using a word processor to modify the text of the script. Further, the scriptable control provides the functionality to create an entire replacement for the operating system shell, again customized via the master script file.

By way of example, and not limitation, the present invention includes a browser window that wraps and hosts the browser control to make it run. The present invention provides the functionality to allow the browser window to be moved around, the borders to be changed, and all other visual and functional attributes to be customized through the common scripting language.

Thus, in effect, the present invention provides a powerful desktop model. The flexibility and accessibility of the model include an easy-to-learn scripting language. The scripting language permits the designer to choose from a wide variety of interface and control components such as backgrounds, button bars, menus, and so on. An exemplary list of the components is found in Table 1. The scripting language also permits the designer to combine the components with commands to create a unique desktop interface. An exemplary list of commands is found in Table 2.

According to an aspect of the invention, a browser window controls the behavior of another browser window. According to another aspect of the invention, a script engine running in the background opens and controls several browser windows. According to yet another aspect of the invention, the browser windows send operational information such as event notifications to the script engine for further processing. According to still another aspect of the invention, a browser window is controlled from outside the window. According to a further aspect of the invention, a script engine runs in the background and controls the interface to browser windows. According to a still further aspect of the invention, a scriptable “shell control” communicating with the kernel of the operating system replaces a traditional shell.

It is contemplated that the invention runs under various operating systems, and relies on a browser being an executable object. Any scripting engine that provides an interface the same or similar to the scripting interface of the present invention can be used to customize the entire user interface. Instead of using compiled programs, the invention uses an editable script such as HTML or Jscript to easily develop any UI.

Further advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

FIG. 1 is a diagram showing an example of basic interfaces for the method and apparatus for producing functionality and user interfaces for a processor-based device having an embedded operating system according to the present invention;

FIG. 2 is a functional block diagram of the architecture of the method and apparatus of FIG. 1; and

FIG. 3 is a flow diagram of a method according to the present embodiment.

### DESCRIPTION OF THE INVENTION

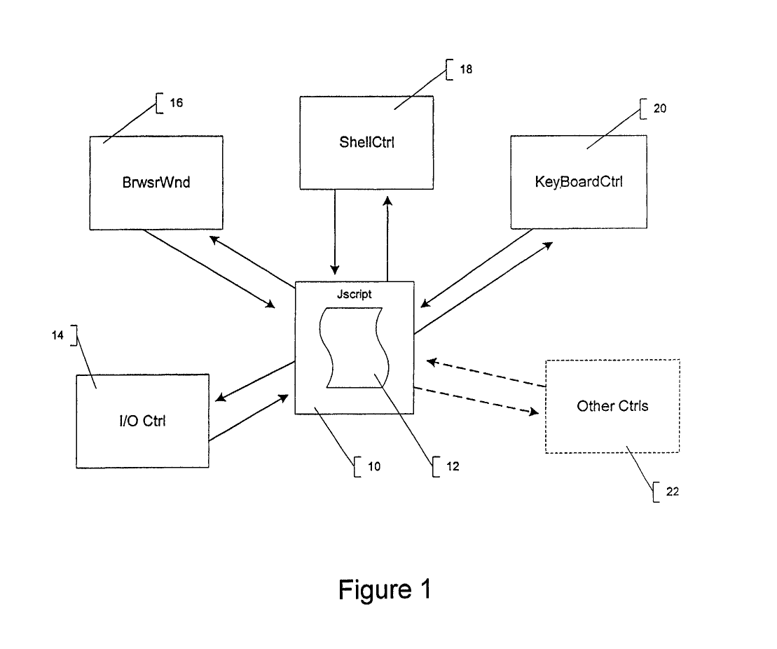

Referring more specifically to the drawings, wherein like references are made to the same items throughout, for illustrative purposes the present invention is generally embodied in the method and apparatus depicted in FIGS. 1-3 of the drawings. A skilled artisan will appreciate that the apparatus and method may vary as to the details of the parts, and that the method may vary as to the specific steps and sequence, without departing from the basic concepts as disclosed herein. Further, one skilled in the art will recognize that the methods and apparatus of the present invention contemplate use of various software components, alone or in combination.

Referring to FIG. 1, a functional diagram of basic interfaces for a method and apparatus for producing functionality and user interfaces for a processor-based device having an embedded operating system according to the present invention is shown. Block 10 shows a scripting engine, such as a Jscript engine, that controls and/or receives information from the other blocks; i.e., software components, shown which are by way of example only.

Block 14 is an input/output control (I/O control). The I/O control provides an easy to use method for performing different input/output methods for performing various input/output actions on the device. The I/O control enables the script to read, write, and delete text files, registry information, and XML files. It has commands for opening the file or registry, reading from the registry, adding new information to the registry and deleting information from the registry. Thus, the I/O control gives the script powerful control over the registry and the files on the device. The following are examples of the functions and events for the I/O Control:

Functions:

OpenFile()

ReadFile()

CloseFile()

WriteToFile()

ResetFile()

GotoLine()

OpenRegistryKey()

ReadRegistryKey()

AddRegistryKey()

DeleteRegistryKey()

ClosingRegistryKey()

Events:

RegistryChanged()

FileChanged()

Block 16 is an example of a first object control, such as a browser window (BrwsrWnd) control. The purpose of the first object control is to provide the script with full control over the browser. The browser window control allows the script to create an interface out of the browser. The control gives the script the ability to control the browser appearance and actions. The first object control also enables the script to receive notification of browser events and gives it full control over those events. The following are examples of the functions and events for the browser control:

Functions:

CreateWnd([in] BSTR bstrURL, [in] LONG xpos,

[in] LONG ypos,

[in] LONG width,

[in] LONG height,

[in] LONG exStyle,

[in] LONG wndStyle);

Browswer ([out, retval] LPDISPATCH *pVal);

SetScript([in] Idispatch* pScript);

SetShell(IDispatch* pShell);

Show()

Move(LONG xpos, LONG ypros, LONG width, LONG height, BOOL bRePaint);

ExecScript([in] BSTR bstrCode, [out,retval] VARIANT* pvarRet);

Events:

. . . from MsHtml

Block 18 is an example of a second object control, such as a shell control (ShellCtrl). The shell control allows the script to gain access to internal shell functionality and to register itself as a shell on the device. The second object control gives the power to specify which window will be the desktop window and what to do with the shell messages, such as WINDOWCREATED and WINDOWDESTROYED. The second object control also gives the script access to device specific information, such as the following system settings: low batter warning, time and date, and display resolution. The second object control provides a number of powerful shell APIs for the shell to use; e.g., Run(), SwitchTo(), Kill(), and ShutDown(). The second object control allows the script to gain full shell control over the other applications running on the device. Examples of functions and events associated with the shell control are:

Functions:

StartShell();

EnShell();

AddMainWindow(ULONG UNLONGMain);

Run([in] BSTR szRunMe, [in] UINT seifMask, [in] ULONG hParent);

RunOnce([in] BSTR szRunMe, [in] UINT seifmask, [in] ULONG hParent);

Kill(ULONG hKill, ULONG hParent);

KillAll(BOOL bwarning);

SwitchTo(ULONG ULONG);

SwitchToNext();

ShowConfigWindow(BOOL bShow);

WaitCursor(BOOL bSet);

Events:

WindowCreated(LONG hWnd, BSTR szTitle);

WidowActivated(LONG hWnd,BSTR szTitle);

WindowDestroyed(LONG hWnd, BSTR szTitle);

WindowRedraw(LONG hWnd, BSTR szTitle);

ShellNotify_IconAdd(LONG hWnd, HICON hIcon);

ShellNotify_IconModify(LONG hWnd, HICON hIcon);

ShellNotify_IconDelete(LONG hWnd, HICON hIcon);

Block 20 shows a keyboard control (KeyBoardCtrl). The keyboard control allows easy mapping of keyboard events to script functions. The keyboard control allows the developer to map script functions to specific function keys such as F1 through F12 and to map specific key sequences such as Alt-Ctrl-Del, Alt-Tab, Ctrl-Backspace, etc. The keyboard control is programmable through the script. One can add or remove key sequence mappings. The control allows the script writer to be informed of the keyboard events no matter what application is currently running. Functions and events associated with the keyboard control include the following:

Functions:

SetKeyMap()

DeleteKeyMap()

Events:

KeyEvent()

Bock 22 shows that miscellaneous controls (other controls) might be integrated as well.

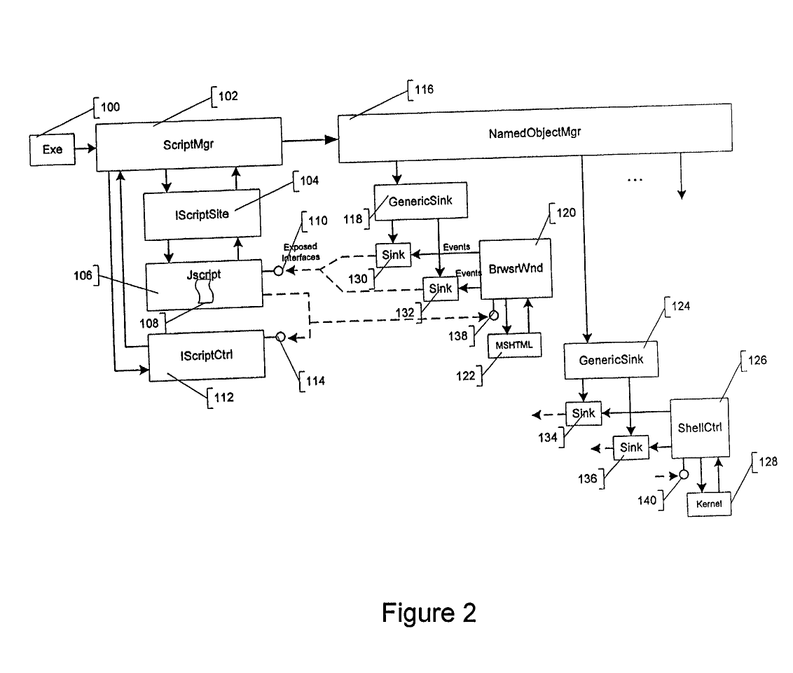

Referring to FIG. 2, the architecture of the invention is shown. At block 100, the operating system boots and launches the shell startup code. This occurs, for example, when a device powers on. Next at block 102, the startup code creates an instance of Script Manager (ScriptMgr). ScriptMgr can be an ActiveX control hosted by any process. Once an instance of ScriptMgr is created, it creates an instance of IScriptSite at block 104. IScriptSite is an interface that communicates with IActiveScript or other interface, which is the contacting point to a script engine 106, such as JScript.dll, which is then loaded. However, the script engine can be any script engine that conforms to the IActiveScript interface (or some other interface that can communicate with the script engine), such as Jscript.dll, VBScript.dll, PerlScript.dll or the like. The script engine 106 in turn runs a master script file 108 which was created by the user. The master script file creates an exposed interface 110 between the script engine and the “outside world” that allows processing of external functions, such as event notifications, from instances of objects that are running on the system. Table 3 provides a list of examples of exposed interfaces for use with the present invention.

At block 112, IScriptCtl is created by ScriptMgr. IscriptCtl receives instructions from the script engine 106 that controls the creation of objects and attached event monitoring attributes as specified by the master script file. In other words, IScriptCtl is a scriptable interface object that gives the user control over the environment through the master script file. IScriptCtl dynamically adds or removes a named object based on information in the master script file received from the script engine 106 through interface 114. For example, IScriptCtl can include “CreateObject” and “ConnectEvent” functions. The “CreateObject” function could, for example, specify that a browser window, such as BrwsrWnd, be created. In addition, it could specify that a shell control object be created, such as IShellCtrl, as will be discussed below. In addition, it would specify events from the created object created to be monitored and processed. As used herein, the term “event” refers to an occurrence where one of the controls notifies another object that something has occurred. Note also that IScriptSite can pass error messages or other information from the script engine back to ScriptMgr.

NamedObjectManager 116 is also created by ScriptMgr if an instance is not already running. NamedObjectManager is shared with all instances of ScriptMgr and is responsible for managing all plug-in ActiveX controls and the like, exposing those named objects to the script engine, as well as managing the existence of a generic sink. For each object created, there will be a corresponding generic sink if the master script calls ConnectEvent to attach to events from that object. For example, there would be a GenericSink array 118 associated with a browser window (BrwsrWnd) 120 if the master script calls ConnectEvent to attach to events from that browser window, such as those sent from MSHTML 122. And, there would be a GenericSink array 124 associated with a shell control (ShellCtrl) 126 that communicates with the operating system kernel 128 if such an object is created and ConnectEvent is called for that object as well. Note that objects can have multiple event interfaces. Each event interface is handled by one generic sink. Generic sink arrays are created when the master script calls ConnectEvent on an event in that event interface. A generic sink array contains one sink per event interface.

For example, in FIG. 2, sinks 130 and 132 are part of GenericSink array 118 and sinks 134 and 136 are part of GenericSink array 124. These sinks are associated with events from the object that are to be monitored and processed by the script engine, there being one such sink for each event interface. In other words, the sinks are communications interfaces between the object and the script engine. The generic sink array would direct the object to create notifications for those events that correspond to those to be monitored by the script engine, based on the master script. For example, when an event is completed in BrwsrWnd 120, it would be passed to sink 130 that corresponds to exposed interface 110 in the script engine 106 to know what took place and act on that event accordingly. As used herein, the “event” is when one of the controls notifies another object that something has occurred. A sink is simply part of the generic sink array for each event interface coming out of the object that corresponds to the exposed functions in the script engine. In this regard, note also that any object can be created directly by the script engine 106, such BrwsWnd 120 through interface 138 for example, or such as ShellCtrl 126 through interface 140 for example, thereby bypassing the event notification process altogether if event notification is not required.

IShellCtrl 126 is an object that replaces the operating system shell. However, unlike a compiled shell with a fixed appearance and functionality, the present invention implements the shell functions as an object with a scriptable interface. In this way, the developer has the freedom to design the appearance and accessibility of the interface for those functions.

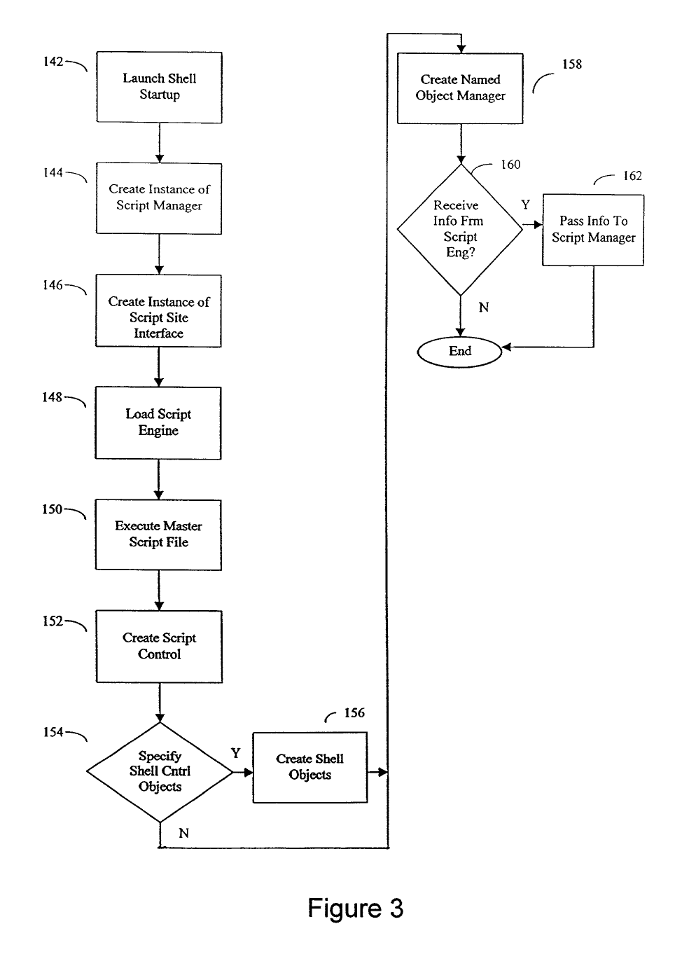

Referring to FIG. 3, a flow diagram of a method according to the present invention is shown for producing user interfaces and device functionality for processor-based devices having an embedded operating system and programming framework. At step 142, the method launches a startup shell, whereafter the startup code creates an Instance of Script Manager at step 144. At step 146, Script Manager creates an instance of Script Site Interface, after which Script Engine is loaded at step 148. At step 150, Script Engine executes the Master Script File, which in turn creates exposed interfaces for processing of external functions and creates Script Control, as shown at step 152. If Shell Control objects are to be created, as shown in step 154, then Script Control creates the objects at step 156. At step 158, Script Manager creates Named Object Manager. If information exists; e.g., error messages, to be received from Script Engine, as shown at step 160, then Script Site Interface passes the information from Script Engine back to Script Manager, as shown in step 162.

In various embodiments there is included an easy-to-use scripting language, hereafter EDL. EDL permits the designer to choose from a wide variety of interface and control elements or components, as heretofore mentioned in conjunction with Table 1. Each component owns a specific type of desktop functionality, such as the button bar along the bottom of the screen, the run dialog, or some type of menu. The designer may also combine the control elements with commands to create a unique desktop interface. Commands are used to hold the information about a particular action that components should perform in response to user input, such as to run a program, show a menu, or even reconfigure the desktop. Additionally, the flexible user management and password system give the designer a high degree of security control over the menus, icons, buttons, and event control panel applets that the desktop interface exposes to the end user of the interface. A sample script in EDL is shown in Sample 1. Included with EDL are multiple sample scripts for use as provided or as modified by the designer.

The process for creating and running an EDL script include the steps of: selecting components to be used in the script; selecting the commands to be used in the script; running the script through an EDL compiler to convert the script into a binary format; downloading the binary file for testing or incorporating the binary file into an operating system image; executing or reading the file with a desktop program.

A design framework for an embedded desktop such as EmbeddedDesktop includes a shell manager, configuration manager, components, factories, and commands. The shell manager controls the configuration phase that involves reading the configuration file and working with the factories. The configuration manager loads up all the factories and opens the configuration file. Each factory is responsible for generating one type of component and setting up that component according to the instructions in the configuration file. The configuration manager reads through the configuration file and distributes information about a component to the proper factory for processing. The factories are each responsible for generating and programming one type of component. The factory uses information sent by the configurations manager to assign commands to the component and to program the component's behavior. Each component owns a specific type of desktop functionality, such as the button bar along the bottom of the screen, the run dialog, or some type of menu. As each component is created by its factory, it registers itself with the shell manager. Commands are used to hold the information about a particular action that a component should perform in response to user input, such as to run a program, show a menu, or even reconfigure the desktop.

Those skilled in the art will appreciate that the invention provides considerable flexibility for running multiple instances of objects and allowing those objects to interact. For example, if we have a first object, that first object can spawn a second object. When the second object does something and wants to tell the first object what was done, it calls the sink of the first object and passes the information assuming the sink was created with ConnectEvent.

Accordingly, the present invention allows a script to modify the look and feel of a system at any time. The script manager creates a script control, which in turn allows a script to control the script manager by dynamically adding and removing objects objects. The script can “subscribe” to event notifications from an object that has been created, and take actions in response thereto, including, but not limited to terminating an object or creating other objects. Note also that, because objects themselves can contain scripts, it is possible to customize the device such that objects can modify the operations or interface to other objects. A “grant access” function may be included to provide an object with a pointer to internal controls, such as the shell control, to give the object access to privileged functionality.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claim. No claim element herein is to be construed under the provisions of 35 U.S.C. 112, sixth paragraph, unless the element is expressly recited using the phrase “means for”.

TABLE 1
COMPONENTS

| Component | Type | Description |
|---|---|---|
| ButtonBar | Screen | Displays a bar with buttons positioned |
| | Element | along the bottom of the screen. |
| ButtonDesktop | Desktop | Displays a desktop with buttons on it. |
| ButtonPanel | Panel | Same as ButtonDesktop but does not act |
| | | as a desktop (is not bottom-most). |
| CommandMenu | Menu | Displays a static menu of command |
| | | choices on the screen. |
| CmdList | Hidden | Defines a batch of commands to be |
| | | run by a Runlist command. |
| EventController | Hidden | Maintains a list of commands to be |
| | | executed at startup, shutdown, |
| | | suspension or reconfiguration. |
| ExternalCmds | Hidden | Exposes EmbeddedDesktop commands |
| | | to external programs. |
| FolderMenue | Menu | Displays a dynamic menu of options |
| | | based on the current contents of a |
| | | specified system folder. |
| IconDesktop | Desktop | Displays a desktop with icons on it. |
| IconPanel | Panel | Same as IconDesktop but does not |
| | | desktop act as a (is not bottom-most) |
| Keyboard | Screen | Displays a software keyboard on |
| | Element | the screen using a keyboard bitmap. |
| PanelUI | Panel | Displays a screen suitable for creating a |
| | | custom control panel. |
| PasswordController | Hidden | Creates passwords and user groups |
| | | to control access to certain commands |
| RunDialog | Dialog | Displays a dialog box for running a |
| | | program directly by entering its |
| | | filename. |
| SystemKeyController | Hidden | Maps system commands to hotkeys |
| TaskManager | Dialog | Displays a dialog box used to switch |
| | | to or kill currently active tasks |
| | | (applications and PanelUI instances) |
| TaskSwitcher | Menu | Displays a menu of currently active |
| | | tasks to switch to. |

TABLE 2
COMMANDS

| Standard Commands | Description |
|---|---|
| AboutBox | Displays a dialog box containing CE |
| | EmbeddedDesktop product information. |
| ChangePasswords | Displays a box for changing user passwords. |
| CloseAllAppsCmd | Closes all running programs. |
| EndCmd | Quits the desktop. (This is a development |
| | tool, not intended to be exposed to the end |
| | user. |
| HideCmd | Hides a window. |
| ReconfigCmd | Restarts and reconfigures the desktop using |
| | the specified desktop configuration file. |
| RunCmd | Launches an external application. |
| RunFolder | Runs all the files in a folder. |
| RunList | Runs a list of commands defined in a |
| | CmdList component. |
| ShowCmd | Shows a window. |
| SwitchCmd | Cycles through running applications. |
| ToggleCmd | Show a window if hidden, hides it if visible. |

| | | Application |
|---|---|---|
| Special Commands | Purpose | Components |
| AddUser | Adds an initial system | PasswordController |
| | password user | |
| ControlApplet | Specifies which | PanelUI |
| | control panel | |
| | applets (from | |
| | .cpl files) to display | |
| EnableBrowse | Enables browse button | RunDialog |
| | and folder name entry | |
| | (by default) | |
| LowPowerWarning | Displays low power | EventController |
| | warning to user. | |
| PopulateFromFolder | Designates path of | FolderMenu |
| | folder from which | |
| | to construct a dynamic | |
| | menu | |
| SelectKB | Identifies .dll file | Keyboard |
| | containing soft | |
| | keyboard information | |
| Separator | Inserts horizontal | CommandMenu |
| | line in menu. | |
| SetBitmap | Sets a background | IconPanel |
| | image for panels | InconDesktop |
| | and desktops. | ButtonPanel |
| | | ButtonDesktop |
| SetBkColor | Sets the background | IconPanel IconDesktop |
| | color for panels and | ButtonPanel |
| | desktops | ButtonDesktop |
| | | ButtonBar |
| SetDblClickMode | Sets whether icons | IconPanel IconDesktop |
| | execute commands on | |
| | single (default) | |
| | on double click. | |
| SetHeight | Sets height in pixels | ButtonBar |
| SetPosition | Sets the position for | CommandMenu |
| | menu components | TaskSwitcher |
| SetTitle | Sets title of component | PanelUI |
| | instance to be | |
| | displayed by | |
| | other components | |
| SetTray | Adds tool tray with | ButtonBar |
| | clock | |
| StopOnError | Stops execution of | CmdList |
| | command list if error | |
| | encountered | |
| SubMenu..EndSubMenu | Commands between | CommandMenu |
| | these appear on new | |
| | cascading submenu. | |
| TabTo/ShiftTabTo | Controls how key- | ButtonBar |
| | board is used to | ButtonPanel/ |
| | select buttons | ButtonDesktop |
| | and icons | IconPanel/IconDesktop |

### SAMPLE 1

IconDeskTop MYDESKTOP

EventController EVENTCTRL

PanelUI MYCONTROLPANEL

PanelUI MYLAUNCHPANEL

[MYDESKTOP]

SetBitMap=“\Windows\YourLogo.bmp”, bkstyle=CENTER

SetBkColor={255, 0, 0}

RunCmd=“filestor.exe”, label =“Manage Files”. icon-“filestor.exe, position={90, 10}

RunCmd=“stime.exe”, “Set Time”, icon=“stime.exe”, position={170, 10}

ShowCmd=MYCONTROLPANEL, label=“Control Panel”, icon=“icons.dll,−121”, position={90, 90}

ShowCmd=MYLAUNCHPANEL, label “Lauch Panel”, icon=“icons.dll,−120”, position={170, 90}

ReconfigCmd=“\Windows\default.dcf”, label=“Reconfigure”, icon=icons.dll,−120,

[MYCONTROLPANEL]

SetTitle =“Contro Panel”

ControlApplet=ALL

[MYLAUNCHPANEL]

RunCmd=“filestor.exe”, label=“Manage Files”, icon=“filestor.exe”, description-“Browse and manage the CE file system”

RunCmc-“stime.exe”, label=“Set Time”, icon=“stime.exe”, Description=“Set Time in Windows CE”

[EVENTCTRL]

ShowCmd-MYDESKTOP, event=STARTUP

ShowCmd-MYDESKTOP, event=RECONFIG

TABLE 3
EXPOSED INTERFACES

| Exposed | | | |
|---|---|---|---|
| Name | Description | Type | Source |
| GoBack | Navigates to the | Browser | IWebBrowser2 |
| | previous item in the | Method | |
| | history list. | | |
| GoForward | Navigates to the next | Browser | IWebBrowser2 |
| | item in the history list. | Method | |
| GoHome | Navigates to the current | Browser | IWebBrowser2 |
| | home or start page. | Method | |
| GoSearch | Navigates to the current | Browser | IWebBrowser2 |
| | search page. | Method | |
| Navigate | Navigates to a resource | Browser | IWebBrowser2 |
| | indentified by a | Method | |
| | Universal Resource | | |
| | Locator (URL) | | |
| Refresh | Reloads the current file. | Browser | IWebBrowser2 |
| | | Method | |
| Stop | Stop opening a file. | Browser | IWebBrowser2 |
| | | Method | |
| get_Document | Returns the active | Browser | IWebBrowser2 |
| | document. | Method | |
| get_Left | Returns the screen | Browser | IWebBrowser2 |
| | coordinate to the left | Method | |
| | edge of the Internet | | |
| | Explorer main window. | | |
| put-Left | Sets the horizontal | Browser | IWebBrowser2 |
| | position of the Internet | Method | |
| | Explorer main window. | | |
| get_Top | Returns the screen | Browser | IWebBrowser2 |
| | coordinate to the top | Method | |
| | edge of the Internet | | |
| | Explorer main window. | | |
| put_Top | Sets the vertical position | Browser | IWebBrowser2 |
| | of the Internet Explorer | Method | |
| | main window. | | |
| get_Width | Returns the width of the | Browser | IWebBrowser2 |
| | Internet Explorer main | Method | |
| | window. | | |
| put_Width | Sets the width of the | Browser | IWebBrowser2 |
| | Internet Explorer main | Method | |
| | window. | | |
| get_Height | Return the height of the | Browser | IWebBrowser2 |
| | Internet Explorer main | Method | |
| | window. | | |
| put_Height | Sets the height of the | Browser | IWebBrowser2 |
| | Internet Explorer | Method | |
| | window. | | |
| get_LocationName | Returns the name of the | Browser | IWebBrowser2 |
| | resource that | Method | |
| | WebBrowser is currently | | |
| | displaying | | |
| get_LocationURL | Returns the URL of the | Browser | IWebBrowser2 |
| | resource that | Method | |
| | WebBrowser is currently | | |
| | displaying. | | |
| get_Busy | Returns a value indicating | Browser | IWebBrowser2 |
| | whether a download or | Method | |
| | other activity is still in | | |
| | progress. | | |
| get_Visible | Returns a value indicating | Browser | IWebBrowser2 |
| | whether the object is | Method | |
| | visible or hidden. | | |
| put_Visible | Sets a value indicating | Browser | IWebBrowser2 |
| | whether the object is | Method | |
| | visible or hidden. | | |
| get_Silent | Returns a value indicating | Browser | IWebBrowser2 |
| | whether any dialog boxes | Method | |
| | can be shown. | | |
| put_Silent | Sets a value indicating | Browser | IWebBrowser2 |
| | whether any dialog | Method | |
| | boxes can be shown. | | |
| get_Resizable | Retrieves the Internet | Browser | IWebBrowser2 |
| | Explorer object's | Method | |
| | resizable property. | | |
| put_Resizable | Sets the Internet | Browser | IWebBrowser2 |
| | Explorer object's | Method | |
| | resizable property. | | |
| BEFORENAVIGATE | this is sent before | Browser | DWebBrowserEvents2 |
| | navigation to give a | Event | |
| | chance to abort. | | |
| NAVIGATECOMPLETE | in async, this is sent | Browser | DWebBrowserEvents2 |
| | when we have enough to | Event | |
| | show | | |
| QUIT | | Browser | DWebBrowserEvents2 |
| | | Event | |
| PROGRESSCHANGE | sent when download | Browser | DWebBrowserEvents2 |
| | progress is updated | Event | |
| WINDOWMOVE | sent when main window | Browser | |
| | has been moved | Event | |
| WINDOWRESIZE | sent when main window | Browser | |
| | has been sized | Event | |
| WINDOWACTIVATE | sent when main window | Browser | |
| | has been activated | Event | |
| PROPERTYCHANGE | sent when the | Browser | DWebBrowserEvents2 |
| | PutProperty method is | Event | |
| | called | | |
| TITLECHANGE | sent when the document | Browser | DWebBrowserEvents2 |
| | title changes | Event | |
| SECURITYICONCHANGE | sent when the security | Browser | |
| | icon needs | Event | |
| VSCROLLCHANGE | sent to indicate state of | Browser | |
| | vscroll buttons | Event | |
| ONBROWSERERROR | sent when an error needs | Browser | |
| | to be reported to the | Event | |
| | user | | |
| BEFORENAVIGATE2 | hyperlink clicked on | Browser | DWebBrowserEvents2 |
| | | Event | |
| NAVIGATECOMPLETE2 | UIActivate | Browser | DWebBrowserEvents2 |
| | new document | Event | |
| ONVISIBLE | sent when the window | Browser | DWebBrowserEvents2 |
| | goes visible/hidden | Event | |
| DOCUMENTCOMPLETE | new document goes | Browser | DWebBrowserEvents2 |
| | ReadyState_Complete | Event | |
| RunScript | Script Control Method | Script | Internal |
| | used by JScript to run | Manager | |
| | another script through | Method | |
| | the Object Name | | |
| | Manager | | |
| TerminateScript | Script Terminate Method | Script | Internal |
| | used by JScript to | Manager | |
| | terminate script started | Method | |
| | through the Object | | |
| | Name Manager | | |
| AddNamedObject | Add a named object to | Script | Internal |
| | the object name manager | Manager | |
| | | Method | |
| RemoveNamedObject | Remove a named object | Script | Internal |
| | added through the object | Manager | |
| | name manager | Method | |
| ConnectEvent | Connect to exposed | Script | Internal |
| | events from an object. | Manager | |
| | Object must have been | Method | |
| | created through the | | |
| | Object Name Manager | | |
| DisconnectEvent | Disconnect from an Event | Script | Internal |
| | connected to through the | Manager | |
| | ConnectEvent Mehtod. | Method | |
| CreateObject | Creates a named object | Script | Internal |
| | and adds it to the list | Manager | |
| | managed by the named | Method | |
| | object manager. | | |
| StartShell | Starts the shell running. | Shell | Internal |
| | | Manager | |
| | | Method | |
| EndShell | Stops the shell from | Shell | Internal |
| | running. | Manager | |
| | | Method | |
| AddMainWindow | Registers the main or | Shell | Internal |
| | desktop window with the | Manager | |
| | OS. | Method | |
| Run | Runs a command string. | Shell | Internal |
| | | Manager | |
| | | Method | |
| RunOnce | Runs a command string, | Shell | Internal |
| | only allowing one of | Manager | |
| | these commands from | Method | |
| | executing at a time. | | |
| Kill | Kills a running windows | Shell | Internal |
| | | Manager | |
| | | Method | |
| SwitchTo | makes a running window | Shell | Internal |
| | the uppermost, i.e.) | Manager | |
| | changes its z-order. | Method | |
| SwitchToNext | makes the “next” running | Shell | Internal |
| | window the uppermost. | Manager | |
| | | Method | |
| ShowConfigWindows | ? | Shell | Internal |
| | | Manager | |
| | | Method | |
| WaitCursor | ? | Shell | Internal |
| | | Manager | |
| | | Method | |
| WindowCreated | Event notification of a | Shell | Internal |
| | window being created | Manager | |
| | | Method | |
| WindowActivated | Event notification of a | Shell | Internal |
| | window being | Manager | |
| | Switched to | Method | |
| WindowDestroyed | Event notification of a | Shell | Internal |
| | window being destroyed | Manager | |
| | | Method | |
| WindowRedraw | Event notification of a | Shell | Internal |
| | window being redrawn | Manager | |
| | | Event | |

What is claimed is:

1. An apparatus for producing user interfaces and device functionality for processor-based devices having an embedded operating system and programming framework, comprising:
scripting means for receiving and storing instructions for a user interface and device functionality on a processor based device;
function means, coupled to said scripting means, for producing interface functions in accordance with the instructions for a user interface and device functionality received from the scripting means; and
output means, coupled to the functions means, for displaying the user interface and applying device functionality on said processor-based device.

2. An apparatus as recited in claim 1, wherein the scripting means includes:
a script writer for writing instruction for a user interface or device functionality; and
a script controller, coupled to the script writer, for producing objects in accordance with the instructions for a user interface or device functionality from the script writer.

3. The apparatus of claim 1, wherein device functionality further comprises control of functionality of a first browser window by a second browser window.

4. The apparatus of claim 2, wherein device functionality further comprises control of multiple browser windows at once.

5. The apparatus of claim 2, wherein device functionality further comprises transfer of operational information to the script controller for further processing.

6. The apparatus of claim 2, wherein device functionality further comprises control of a browser window from outside the window.

7. The apparatus of claim 2, wherein device functionality further comprises scriptable shell control for replacement of a shell of an operating system.

8. The apparatus of claim 2, wherein the function means further comprises a shell manager.

9. The apparatus of claim 2, wherein the function means further comprises a configuration manager.

10. The apparatus of claim 2, wherein the function manager further comprises at least one factory.

11. The apparatus of claim 2, wherein the function manager further comprises commands.

12. The apparatus of claim 2, wherein the function manager and the interface manager further comprise components.

13. An apparatus for producing user interfaces and device functionality for processor-based devices having an embedded operating system and programming framework, comprising:
a scripting engine for executing a script file;
an input/output control for performing multiple actions on the device;
a first object control for providing control over a first object;
a second object control for providing control over a second object;
a keyboard control for providing control over keyboard events; and
a miscellaneous control for providing control functionality over various computer components.

14. The apparatus of claim 13, wherein the scripting engine further comprises Jscript.

15. The apparatus of claim 13, wherein the first object further comprises a browser window.

16. The apparatus of claim 13, wherein the second object further comprises a shell control for gaining access to internal shell functionality and to register as a shell on the devices.

17. A method for producing user interfaces and device functionality for processor-based devices having an embedded operating system and programming framework, comprising:
launching a shell startup program;
creating by the shell startup program an instance of a script manager;
creating by script manager an instance of a script site interface;
loading a script engine associated with the script site interface;
executing a master script file by the script engine;
interfacing by the master script to permit processing of external functions;
creating a script control by script manager for receiving instructions from the script engine and adding and removing named objects based on information in the master script file; and
creating named object manger by script manager for exposing named objects to the script engine and managing the existence of a generic sink.

18. The method of claim 17, further comprising the step of passing information from the script engine to script manager by the script site interface.

19. The method of claim 17, further comprising the step of specifying creation of a shell control object by script control.

20. The method of claim 17, further comprising the step of creating and using an EDL script file consisting of the substeps of:
selecting components to be used in the script;
selecting the commands to be used in the script;
compiling the script via an EDL compiler to produce a binary file;
downloading the binary file for testing or incorporating the binary file into an operating system image.
